(19) United States
(12) Patent Application Publication
(10) Pub. No.: US 2008/0049214 A1
(43) Pub. Date: Feb. 28, 2008

(54) Measuring Diffractive Structures By Parameterizing Spectral Features

(76) Inventors: Alexei Maznev, Natick, MA (US); Carlos A. Duran, Canton, NY (US); Michael Gostein, Austin, TX (US); Alexander Mazurenko, Dedham, MA (US); Gregory T. Merklin, Watertown, MA (US); Peter Rosenthal, West Simsbury, CT (US); Anthony S. Bonanno, Ellington, CT (US)

Correspondence Address: GOODWIN PROCTER LLP;PATENT ADMINISTRATOR, EXCHANGE PLACE, BOSTON, MA, 02109-2881, US

(21) Appl. No.: 11/846,123

(22) Filed: Aug. 28, 2007

Related U.S. Application Data
(60) Provisional application No. 60/823,685, filed on Aug. 28, 2006.
(60) Provisional application No. 60/903,166, filed on Feb. 23, 2007.

(51) Int. Cl. G01B 11/00

(52) U.S. Cl. 356/51

(57) ABSTRACT

Structures are characterized by exposing a sample to optical radiation, measuring a spectrum associated with the exposure, detecting at least one characteristic parameter in the measured spectrum, and computing at least one structural parameter based on the at least one characteristic parameter.

### CROSS-REFERENCE TO RELATED APPLICATIONS

This application claims the benefit of and priority to U.S. Provisional Application Ser. No. 60/823,685, filed Aug. 28, 2006, and U.S. Provisional Application Ser. No. 60/903,166, filed Feb. 23, 2007, the entire disclosures of which are hereby incorporated by reference.

### FIELD OF THE INVENTION

The technology disclosed herein relates to measuring the dimensions of structures formed in the fabrication of devices such as integrated circuits.

### BACKGROUND

The fabrication of semiconductor devices for integrated circuits typically involves generating dense arrays of three-dimensional structures. For example, a workpiece consisting of a semiconductor substrate or a substrate with one or more deposited film layers may be etched to form arrays of linear trenches, cylindrical cavities, or other shapes. We collectively refer to such structures as “trenches” or “trench arrays,” regardless of geometry. These features may be filled with a fill material or coated with a deposited layer, after which an etching process may be repeated to form a more complex structure.

Device manufacturers need the ability to characterize the geometric aspects of such structures, e.g., depths and widths, after the structures are formed. Desirably, these parameters are characterized rapidly and non-destructively, in order to permit routine process monitoring. Accordingly, non-contact measurement techniques, such as optical metrology methods, are typically preferred when available.

Many optical techniques used for measuring semiconductor device structures are spectroscopic in nature. These include both spectroscopic reflectometry and ellipsometry, in which analysis of the optical response versus wavelength (i.e., the spectrum) is used to determine sample properties. Alternatively, some techniques measure the optical response as a function of angle. The signature of the response versus angle is then analyzed to determine sample properties. Herein, we collectively refer to both types of measurements as “spectra,” whether the response is measured as a function of wavelength or angle.

Analysis of spectroscopic data from such instruments generally involves modeling to recover the desired structure parameters. The analysis problem may be considered as two sub-problems. The first is the “forward” modeling problem: a model of the sample is constructed which includes parameters describing the main geometric aspects of the structures to be measured, as well as the optical properties of the materials comprising the structures and substrate, and calculations are then performed which simulate the corresponding spectrum based on appropriate physics. The second problem is the “inverse” problem: given a measured spectrum, finding the values of the model parameters which would produce, in simulation, a desired fit to the measured spectrum.

The inverse problem is commonly encountered in many areas of science and engineering. When possible, it is usually solved using an iterative fitting approach, in which trial values of the model parameters are iteratively adjusted until the simulated and measured spectra agree to within a pre-determined value of a convergence metric. However, this approach generally requires that the spectrum simulation (i.e., the forward analysis) be performed rapidly since the simulation is typically repeated many times in the course of a measurement.

For measurements of structures using optical spectroscopy, the complexity of the spectrum simulation increases when the optical wavelength is comparable to a characteristic lateral dimension of the structure, e.g., within a factor of 10, or even within a factor of 100. In this case, the effects of optical diffraction become significant and the spectra become complex and irregular. Measurements in this regime are known in the art as “scatterometry.” Different kinds of scatterometry instruments have been developed to measure spectra as a function of both wavelength and angle. Measurement of grating profiles with spectroscopic scatterometry are described, for example, in X. Niu, et al., IEEE Trans. Semiconductor Manufacturing, Vol. 14, No. 2, p. 97 (2001), the entire disclosure of which is hereby incorporated by reference. Accurate spectrum simulation in the presence of diffraction generally requires the use of computationally intensive techniques such as rigorous coupled wave analysis (“RCWA”). The computation time required to simulate a spectrum with RCWA depends on many factors; however, for many applications in semiconductor device metrology, the calculation time is often too long to permit the use of RCWA in an iterative fitting approach.

Makers of semiconductor metrology equipment have employed various approaches to the solution of the inverse problem when RCWA spectrum simulation is required. A common approach is to rely on matching the measured spectrum with entries in a library of pre-calculated spectra. In this approach, RCWA simulation is used in advance of the measurement to generate spectra corresponding to many potential combinations of the model parameters, and the resulting spectrum library is saved in a database. A measured spectrum is then compared to entries in the database and the model parameters providing a best fit are taken from the database or found by interpolation between database entries. Because the objective is to obtain a close match between the measured spectrum and a pre-calculated one, this approach typically requires calculation of a large number of spectra to sufficiently populate the database, ensuring that the library captures the variations of all nuances of the spectra—whether or not these nuances relate to the parameters of interest. Accordingly, calculation of the library spectra can itself become very time-consuming. Furthermore, searching the database efficiently and, when needed, interpolating between database entries become new computational problems that must be solved in order to permit rapid measurement.

Therefore, there exists a need for an improved approach to measuring optically diffracting microstructures using spectroscopic techniques, which minimizes the computational burdens of generating, searching, and interpolating pre-calculated spectrum libraries.

### DESCRIPTION OF THE INVENTION

### Brief Summary of the Invention

In accordance with embodiments of the present invention, pre-calculated spectra are analyzed to extract parameters which capture important characteristics of the spectra. A functional relationship is established between the spectrum parameters and the structure parameters. This functional relationship is used in the subsequent measurement of samples, translating measured spectra into physical parameters of the samples.

Accordingly, in a first aspect, the invention features a method of characterizing a sample that includes a periodic array of structures. The periodic array may include a series of substantially identical structures having substantially similar lateral dimensions. The sample is exposed to electromagnetic radiation, which is reflected by, transmitted through, or diffracted by the sample. Thereafter, a spectrum associated with the exposure is measured, and at least one characteristic parameter of the measured spectrum is detected. The characteristic parameter varies identifiably with at least one structural parameter over a range of values of the structural parameter. The structural parameter is computed based on the at least one characteristic parameter. A wavelength of the electromagnetic radiation may be less than a characteristic diffraction threshold of the sample, and/or comparable to lateral dimension of the periodic array (e.g., within a factor of 10, or even within a factor of 100). The at least one characteristic parameter may include at least one of a position or an intensity of a feature of the spectrum, e.g., a local maximum or minimum. The at least one characteristic parameter may correspond to at least one of a slope, a curvature, an area, or a frequency of a region of the spectrum.

The method may further comprise fitting a functional form to the spectrum, where the at least one characteristic parameter includes a parameter of the functional form. The at least one structural parameter may include at least one of a depth, a width, a thickness, a pitch, or an angle. Multiple structural parameters may be computed.

Computing the at least one structural parameter may include operating on the at least one characteristic parameter with a calibration. In an embodiment, the calibration is established by constructing a model of a periodic array of structures, the model including a plurality of structural parameters to be measured, and defining a range of variation for each of the structural parameters. Based on the model, a spectrum of the plurality of structures over a wavelength range of the radiation is simulated. The simulation is repeated for multiple values of the structural parameters over the defined range of variation, thereby forming a plurality of simulated spectra. Characteristics of the simulated spectra having an identifiable variation with respect to the structural parameters are identified. Values are assigned to the characteristics, thereby obtaining characteristic parameters of the simulated spectra. At least one function relating the characteristics to the structural parameters is established.

Embodiments of the invention may include at least one of the following. The at least one function may include at least one of an equation or a table. Simulating each spectrum may account for diffraction effects. A plurality of sub-ranges for at least one of the characteristic parameters of the simulated spectra may be identified, where each function corresponds to a different sub-range. The calibration may be stored in a library which includes a plurality of records. Each record may include values of the structural parameters used to generate one of the simulated spectra, as well as values of the characteristic parameters of that spectrum. Computing spectrum parameters may include comparing at least one characteristic parameter to the characteristic parameters in the library records to find a best-matching record, as well as selecting the function corresponding to the best-matching record.

The calibration may include a calibration equation including multiple parameters, and/or higher powers or cross-products of the characteristic parameters of the simulated spectra or the structural parameters. Establishing the at least one function may include determining a plurality of calibration factors using a multivariate regression technique. The wavelength range may include a wavelength greater than a diffraction threshold of the sample, and assigning the values may include fitting the simulated spectra to an effective medium model.

The electromagnetic radiation may include infrared radiation. The source of the electromagnetic radiation may be spectrally resolved with an FTIR spectrometer.

In another aspect, the invention features an apparatus including a source of electromagnetic radiation of exposing a structure thereto, as well as a detector for measuring a spectrum based on the exposure, detecting characteristics of the measured spectrum that vary identifiably with at least one structural parameter over a range of values of the at least one structural parameter, and computing structural parameters based on the characteristics of the measured spectrum. The detector may include a calibration established by the steps outlined above. The simulated spectra of the calibration may include the effects of diffraction. The electromagnetic radiation may include infrared radiation. The source of the electromagnetic radiation may be spectrally resolved with an FTIR spectrometer.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 schematically depicts an exemplary array of trenches which may be characterized by various embodiments of the invention;

FIG. 2 schematically depicts a reflectometry system utilized in various embodiments of the invention;

FIG. 3 illustrates a comparison between measured reflectance spectra and simulated reflectance spectra;

FIGS. 4A and 4B illustrate variations in simulated spectra as a function of particular trench parameters;

FIG. 5 illustrates the relationship between spectrum parameters and model parameters established according to various embodiments of the invention;

FIG. 6 graphically depicts measured trench parameters for test structures as derived according to embodiments of the invention;

FIG. 7 illustrates normal and abnormal spectra as identified according to embodiments of the invention;

FIG. 8 schematically depicts an exemplary array of trenches which may be characterized by various embodiments of the invention; and

FIG. 9 illustrates variations in simulated spectra as a function of a particular parameter of the structure depicted in FIG. 8.

### DETAILED DESCRIPTION OF THE PREFERRED EMBODIMENTS

1. Recipe Development

In accordance with embodiments of the invention, recipes are developed which facilitate the metrology of unknown samples in a cost-effective manner. The development of such recipes and the performance of such subsequent metrology is thereby less computationally intensive than prior techniques.

First, a model of a particular structure to be measured is constructed. The parameters in the model (i.e., the “model parameters”) include various characteristics of the structural features, including but not limited to thicknesses, depths, widths, angles, and pitches. The structure may be an array of unfilled or filled linear or cylindrical trenches, although it should be understood that the trenches may be otherwise shaped. Moreover, the trenches may be formed directly in a substrate (e.g., by etching), or in a more complex structure including at least one layer of another material on the substrate. The substrate may also include previously formed structures beneath or approximately coplanar to the trenches. The model parameters may include not only trench features that are nominally constant, but also those that may vary due to excursions in the fabrication process. A range of variation for each model parameter is typically defined. Preferably, the range of variation is larger than the range expected due to processing excursions.

Next, a plurality of simulated spectra are generated based on the ranges of variation of each of the model parameters. A series of simulated spectra are produced for each unique combination of model parameters, such that the variation of each model parameter is captured in several simulated spectra (each corresponding to a particular parameter value within the range). The spectra are simulated by a suitable computational method such as RCWA.

Useful features are then identified in the simulated spectra. A useful spectral feature is one that is easily identified, is susceptible to accurate measurement, and exhibits sensitivity to variations in the model parameter of interest. Useful features include, but are not limited to, the positions of minima or maxima in the spectra, the amplitudes of such minima or maxima, the slope or curvature of a region of the spectrum, the area of a spectral region, and/or the frequency of a portion of the spectrum which oscillates in amplitude. Moreover, useful features have discrete values (e.g., wavenumbers of maxima or minima in the spectra) that correlate predictably with one or more model parameters. The identification of useful features may be performed by, e.g., a skilled engineer, based on the discreteness and identifiability of the feature and the degree of correlation to a model parameter (i.e., the variation as a function of variation in a model parameter).

Once suitable useful features of the spectra are identified, a mathematical operation which extracts parameters of the spectra that quantify the useful features (i.e., the spectrum parameters) is selected. The operation desirably assigns discrete values to the useful features of each spectrum (e.g., the wavenumbers of useful maxima and/or minima). The operation may involve, e.g., determining peak positions and/or intensities, fitting the spectrum to an arbitrary functional form, or other operations such as derivatives, integrals, and/or Fourier transforms performed on the spectrum. A functional form to which the spectra are fitted may include polynomial, sinusoidal, and/or exponential terms, and/or other arbitrary functions, including functions that are not expressed analytically in closed form but require numerical evaluation. The functional form should provide a good quantification of the identified useful feature, should apply over as large as possible a range of variation of the model parameters, and should quantify the feature with minimal confusion with respect to other features. The operation is performed on each of the simulated spectra, providing the spectrum parameters. For each spectrum, values of the spectrum parameters and of the corresponding model parameters are stored in a parameter table.

In various embodiments, a calibration—i.e., a functional relationship that best connects the spectrum parameters and the model parameters in the parameter table—is constructed. The calibration may be, e.g., a polynomial function or a matrix equation. Utilization of the calibration enables the prediction of a set of model parameters for a given set of spectrum parameters. In various embodiments, prediction errors are minimized by constructing the calibration through the use of multivariate data regression applied to the sets of spectrum and model parameters. Examples of suitable regression techniques include multiple linear regression or partial least squares, as described in R. Kramer, Chemometric Techniques for Quantitative Analysis, Marcel-Dekker, Inc., New York 1998, the entire disclosure of which is hereby incorporated by reference. Once constructed, the calibration is stored (e.g., in memory associated with a measurement system for obtaining spectra from samples to be measured) for later use, e.g., in metrology as described below. The recipe created for a particular application includes the calibration, as well as the set of model parameters to which it applies. A measurement system may contain several recipes, each for a different application, type of sample, or set of model parameters of interest.

In some embodiments, the measurement system may implement the functionality of the present invention (including, e.g., recipe creation, recipe storage, and sample measurement as described below) in hardware or software, or a combination of both on a general-purpose computer, which may be a part of or connected to the detector. In addition, such functionality (e.g., a program) may set aside portions of a computer's random access memory to provide control logic that affects one or more of the image manipulation, segmentation, and display. In such an embodiment, the program may be written in any one of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software can be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, a DVD-ROM, or a CD-ROM.

2. Sample Measurement

In accordance with various embodiments of the invention, various parameters are accurately measured via utilization of recipes (generated as described above). First, a sample, which may include a plurality of trench features, is exposed to electromagnetic radiation to generate a corresponding measured spectrum. The measurement may be performed by, e.g., optical spectrometry and/or reflectometry, using a suitable measurement apparatus, such as an infrared reflectometry system (e.g., the IR3000 Model-Based Infrared Reflectance system available from Advanced Metrology Systems, LLC of Natick, Mass.). Other suitable apparatus include reflectometers, ellipsometers, Fourier-transform infrared (“FTIR”) systems, x-ray systems, or other spectrometers, diffractometers, or scatterometers. The incident radiation may have wavelengths in the x-ray, ultraviolet, visible, and/or infrared range.

The mathematical operation selected during recipe development is applied to the measured spectrum in order to derive values of spectrum parameters associated with the recipe. These spectrum parameters are utilized as inputs to the calibration generated during recipe development to generate values of model parameters of the measured sample.

In some embodiments, the parameter table established during calibration is used directly (i.e., as a look-up table) to translate measured spectra into model parameters. In this case, the parameter table is searched to find the most closely matching set of spectrum parameters, and its corresponding model parameters are reported as the measurement results.

In various embodiments, multiple sub-calibrations are used in lieu of a single calibration; each sub-calibration thus applies to a specific sub-range of the parameter space. The sub-range may be identified during measurement either by searching the parameter table (i.e., in a look-up technique) to identify the sub-range, or by applying a mathematical operation to the spectrum parameters. For example, certain combinations of the spectrum parameters may be identified as belonging to one sub-range, while other combinations belong to another. Once a sub-range is identified, a sub-calibration is utilized to determine the values of the model parameters in the sub-range associated with the spectrum parameters. This approach is advantageous when the range of variation of the model parameters and spectrum parameters is such that a single calibration function spanning the entire range cannot be easily established, but several sub-calibrations (corresponding to portions of the parameter table) may be created. For example, the use of multiple sub-calibrations may be preferred when the spectrum parameters and/or the model parameters are highly nonlinear or non-monotonic, and thus may not be easily described by a convenient function over the entire range. Moreover, multiple sub-calibrations may be advantageously utilized when a selected useful feature is not visible in the spectra over the entire range of variation of the model parameters. In such a case, several useful features are preferably used, each one applying to a different sub-range and utilizing a different sub-calibration.

Some embodiments of the present invention include additional pre-processing and/or filtering steps after measurement of the sample but before performing the calculations determining model parameters from the measured spectrum parameters. The pre-processing and filtering steps reveal when unsuitable spectra have been measured (e.g., when a spectrum contains no features identified as spectrum parameters in recipe development). Such unsuitable spectra are rejected before the computation of model parameters is attempted (since this would likely be unsuccessful), thus conserving computation resources. Moreover, if a measured spectrum contained spectrum parameters falling outside of the range of interest identified during recipe development (and hence for which no model spectra were simulated), the measured spectrum could be rejected as unsuitable for use with the selected recipe.

In embodiments of the invention, different combinations of the look-up table, calibration, multiple-calibration, pre-processing, and/or filtering techniques are utilized. Such steps may be combined in various orders and numbers, depending on the type of samples to be measured and data to be analyzed.

Embodiments of the present invention advantageously reduce the calculation burden associated with generating spectrum libraries for use in optical metrology, as a close direct match between each measured spectrum and a pre-generated spectrum is unnecessary. Instead, comparison takes place between discrete parameters that reflect salient spectral features. This represents a substantial improvement over prior systems that require the calculation of pre-generated spectra that include all possible combinations of model parameters with sufficient density to capture all nuances of the spectra. In embodiments of the present invention, only enough initial spectra are calculated to enable the identification and quantification of the variation of relevant spectral characteristics (i.e., the useful features described above). Moreover, only the most useful features (i.e., those displaying the most variation as a function of variation of the model parameters), or a minimum set thereof, need be utilized in the recipe development and subsequent measurement. Less salient useful features need not be tracked or utilized, thereby reducing the amount of requisite computation and facilitating the use of a small set of model parameter combinations for generation of the initial library. And because measured model parameters are directly calculated from the spectrum parameters of the measured spectrum (e.g., via a calibration), the need for computationally intensive library searches and/or interpolations is eliminated.

3. Diffraction Threshold

Diffraction occurs when the optical wavelength is less than the diffraction threshold, i.e., the wavelength at which diffraction first appears. This is calculated from the geometry of the measurement. For example, for a light beam incident at an angle θ onto a linear trench pattern etched in a substrate, with the plane of incidence parallel to the trenches, the diffraction threshold is given by
λ_{D}=Λ\sqrt{n²+sin²θ}, [1]
where Λ is the period of the trench pattern, θ is the incidence angle, and n is the refractive index of the substrate, which is assumed to be transparent (as silicon is in the mid-infrared). Determination of the diffraction threshold for various different cases such as a different trench configuration, an opaque (e.g., metallic) substrate, or others, may be performed by methods well known in the art.

It should be noted, however, that at wavelengths just above the diffraction threshold, the optical spectrum may still show complexities that require RCWA or other computationally intensive means for spectrum simulation. Accordingly, embodiments of the invention are advantageously applied to trench structures having diffraction thresholds below a measurement wavelength. In particular, embodiments of the invention are applied to “diffracting structures” in the wavelength range that is just above the diffraction threshold as well as the range that explicitly includes diffraction. In an embodiment, the wavelength range includes wavelengths greater than the diffraction threshold but less than approximately twice the diffraction threshold.

4. Parameterization Using an Effective Medium Model

In the wavelength range above the diffraction threshold, it may be advantageous to parameterize the spectrum by fitting to an effective medium model (as described below), which would ordinarily be used when the wavelength greatly exceeds the diffraction threshold. The effective medium model is generally derived in situations where the wavelength greatly exceeds the diffraction threshold, e.g., where the wavelength is greater than approximately twice the diffraction threshold. In this case, the structure may be analyzed as though it were composed of homogeneous layers with effective optical properties determined by an effective medium approximation, as described in, e.g., S. Zaidi et al., “FTIR-based non-destructive method for metrology of depth in poly silicon filled trenches”, Proc. SPIE, Vol. 5038, p. 185 (SPIE, 2003), the entire disclosure of which is hereby incorporated by reference.

In the wavelength range near but just above the diffraction threshold, the effective medium model may not accurately predict the spectrum when strictly applied. However, in this range it may be adapted to fit the spectrum by including artificial dispersion terms, as described in published PCT Patent Application No. WO2007004177, the entire disclosure of which is hereby incorporated by reference.

In accordance with embodiments of the present invention, an effective medium model may be used as a fitting vehicle to parameterize the spectrum of structures measured in the wavelength range just above the diffraction threshold. The parameters of the model (e.g., void fractions and layer thicknesses), while not necessarily accurate measures of the structure dimensions, serve effectively as spectrum parameters which can then be converted into actual dimensions (i.e., model parameters) using the methods described above. This approach may be particularly advantageous in cases in which the effective medium model provides a fit to the spectrum with fewer free parameters than may be obtained with other arbitrary functions.

### Example 1

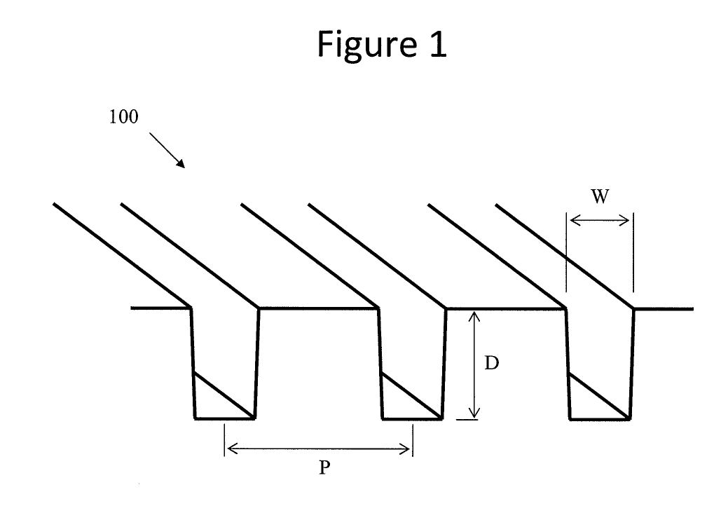

FIG. 1 illustrates an array of linear trenches 100 etched in a substrate, e.g., a silicon substrate, with array pitch P of 1.5 micrometers (μm), trench depth D of 1.0 μm, and trench width W of 0.4 μm. This structure may occur, for example, in the fabrication of some power metal-oxide-semiconductor field-effect transistor (“MOSFET”) devices.

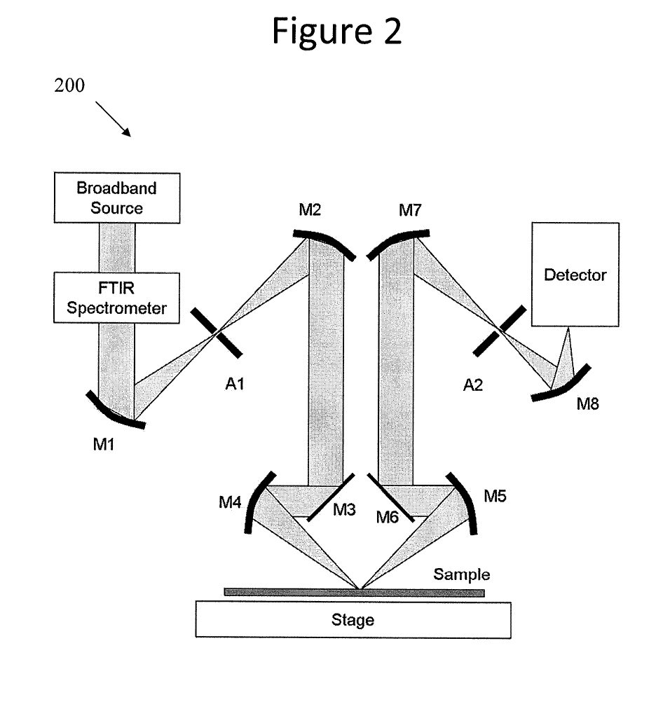

Array 100 is measured with a suitable measurement instrument 200, e.g., the IR3000 system mentioned above. This instrument has a wavelength range of 1.4 to 20 μm (corresponding to a wavenumber range of 500 to 7000 cm⁻¹), and measures the reflectance spectrum of the sample at a 45° angle of incidence. The instrument design is based on a broadband light source coupled with an FTIR spectrometer and an optical system for illuminating the sample and collecting the reflected light, as shown in FIG. 2. On its path from the light source to the detector, the optical radiation is reflected by a series of mirrors M1-M8 and travels through apertures A1 and A2. Since pitch P of array 100 falls within the measurement wavelength range of instrument 200, array 100 is particularly suitable for measurement using the techniques detailed above.

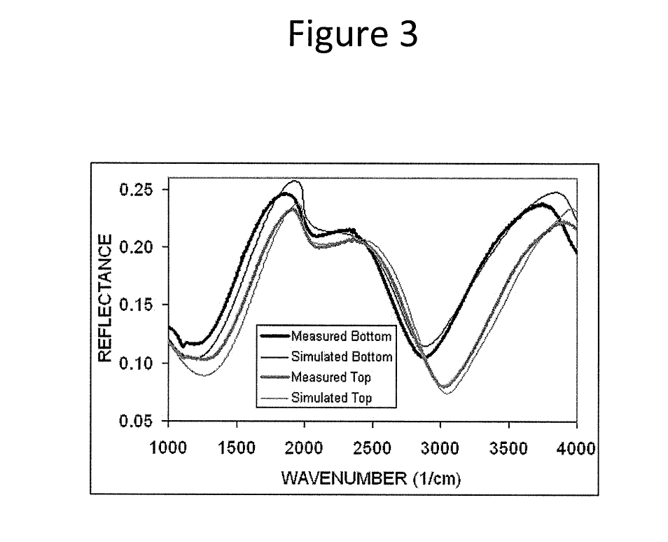

A test wafer containing array 100 was produced, with intentional variations in the processing parameters that produced variations in the trench depth D and width W at different portions of the wafer. FIG. 3 shows reflectance spectra obtained at two locations on the test wafer, measured with the incidence plane parallel to the trenches, as well as corresponding RCWA simulated spectra. The simulated spectra agree well with the measured ones. In particular, the simulation model precisely describes the locations of two useful features, i.e., the diffraction minima between 1000-1500 cm⁻¹ and between 2500-3000 cm⁻¹.

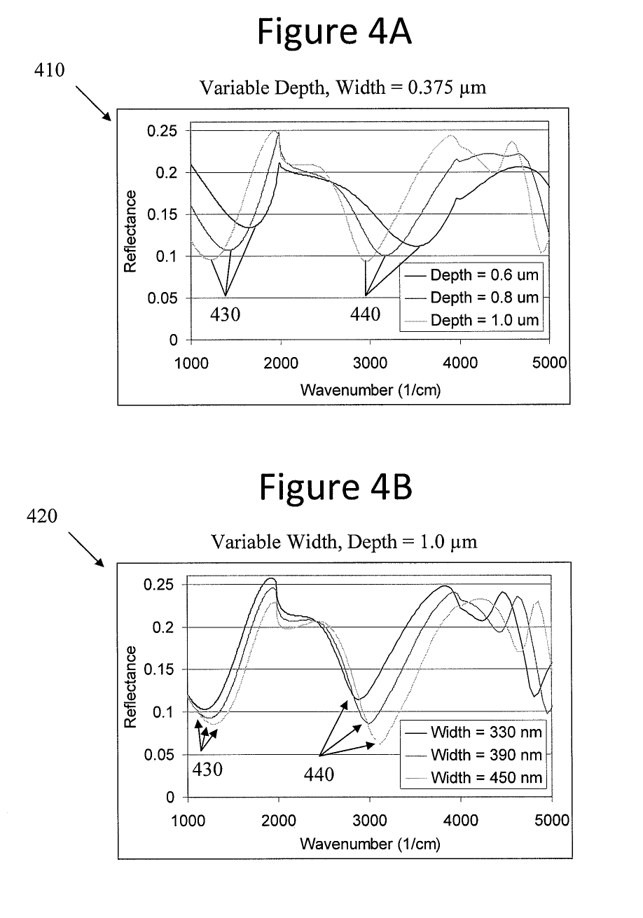

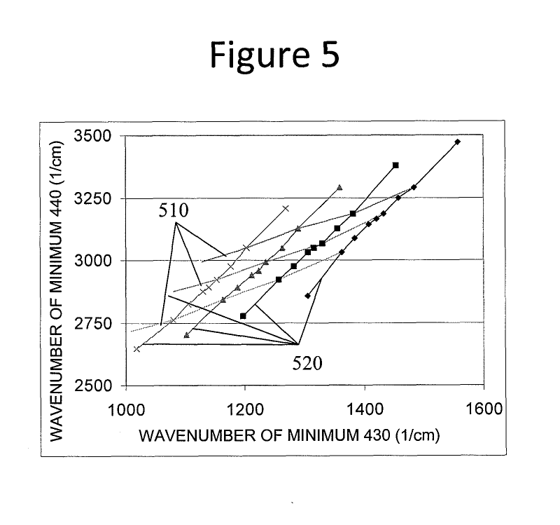

In accordance with embodiments of the invention as described above, recipe development was performed by simulating the reflectance spectra of the test wafer for a range of variations of the model parameters. Only the depth D and width W parameters were varied, as pitch P was assumed to be well controlled in the manufacturing process. FIG. 4A shows selected simulated spectra 410 that illustrate the effects of variations in the depth D of array 100. Similarly, FIG. 4B shows selected simulated spectra 420 that illustrate the effects of variations in the width W. In particular, it can be seen that the wavenumber locations of the first two interference minima 430, 440 in the reflectance spectra depend on both the depth and width of the trenches. Furthermore, the dependence of the positions of minima 430, 440 on the depth D and width W is different; the position of first minimum 430 changes more as a function of D than as a function of W, while the position of second minimum 440 changes as a function of D and W similarly. Thus, D and W may be simultaneously determined. The positions of minima 430, 440 were therefore identified as useful features and were selected as the spectrum parameters for parameterization of the spectrum. The positions of minima 430, 440 were tabulated for a range of variation of the model parameters D and W. The relationship between the spectrum parameters and the model parameters is illustrated in FIG. 5. Lines of constant width 510 illustrate the variation of the positions of minima 430, 440 as a function of depth, and lines of constant depth 520 show the same as a function of width. It will be appreciated that these relationships, tabulated in a parameter table, can also be described by a linear matrix equation.

Accordingly, using linear algebra notation, a calibration relationship was expressed as

$$( \begin{matrix}Depth \\ Width\end{matrix} ) = C \times ( \begin{matrix}First Minimum Position \\ Second Minimum Position \\ 1\end{matrix} ) \qquad [ 2 ]$$

where C is the calibration matrix, and × denotes the matrix outer product. The calibration matrix in this case takes the form:

$$C = ( \begin{matrix}{c}_{11} & {c}_{12} & {c}_{13} \\ {c}_{21} & {c}_{22} & {c}_{23}\end{matrix} ) \qquad [ 3 ]$$

The coefficients cᵢⱼ were determined by multiple linear regression on the parameter table described above.

Equation [2] relates the spectrum parameters to the model parameters in a linear fashion. Non-linear dependencies may be incorporated into the calibration by the inclusion of additional elements, such as higher powers or products of the various parameters. Correspondingly, the number of columns in the calibration matrix C would increase with the addition of higher order terms. The relationship between spectrum parameters and model parameters (e.g., that depicted in FIG. 5) may often be non-linear. For example, if the lines of constant D and constant W of FIG. 5 displayed more curvature, addition of non-linear terms might be necessary. However, over narrow ranges, the relationship may be linear enough such that a linear approximation (as utilized above in Equation [2]) provides the desired level of accuracy. A choice between a linear approximation and a non-linear one (i.e., one both more accurate but more complex) may be made by fitting both to the data and comparing the relative prediction error across the parameter table. If the prediction error resulting from the use of a linear approximation is small or negligible, the linear approximation may be advantageously utilized to decrease the amount of computation required to derive model parameters from spectrum parameters. For example, in the case illustrated in FIG. 5, non-linear terms were added to Equation [2] but were found to be unnecessary. In more complicated embodiments, non-linear terms may be necessary and are advantageously utilized.

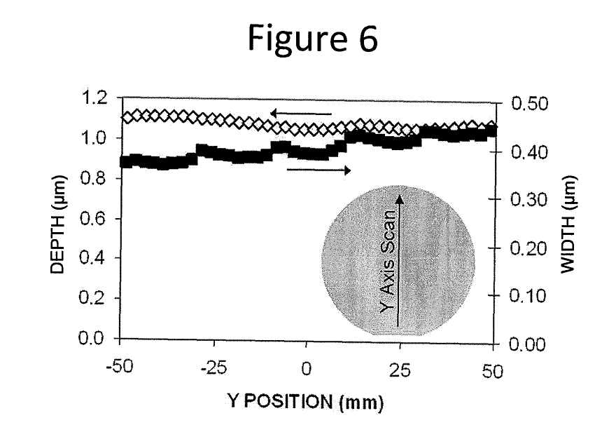

The calibration established during the recipe development step was applied to the test wafer described above. FIG. 6 shows the measurement results of a diameter scan on the same wafer measured in FIG. 3. The change in trench width is clearly visible, while the trench depth stays relatively constant across the wafer. This result is in agreement with expectations based on the wafer processing.

The repeatability of the method was evaluated by repeating the measurement 20 times on several dies scattered on the wafer. The wafer was removed and repositioned back into the system after each measurement. The average single-die repeatability values for width and depth were 0.25% and 0.24% (1σ), respectively. These values met normal process control requirements, which were typically 3σ<1-2%.

In order to test the accuracy of the technique at different trench depths, measurements on a set of wafers with different trench depths were carried out. The wafers were processed in pairs of “sister” wafers; one wafer of each pair was analyzed by scanning electron microscopy (“SEM”) while the other was measured using the infrared reflectometer and analyzed in a similar manner to that described above. Results were in good agreement, as shown by the table below.

Measured
Trench Depth (microns)

| Sample Number | SEM | Infrared reflectometry |
|---|---|---|
| 1 | 1.00 | 1.00 |
| 2 | 1.40 | 1.35 |
| 3 | 1.67 | 1.65 |

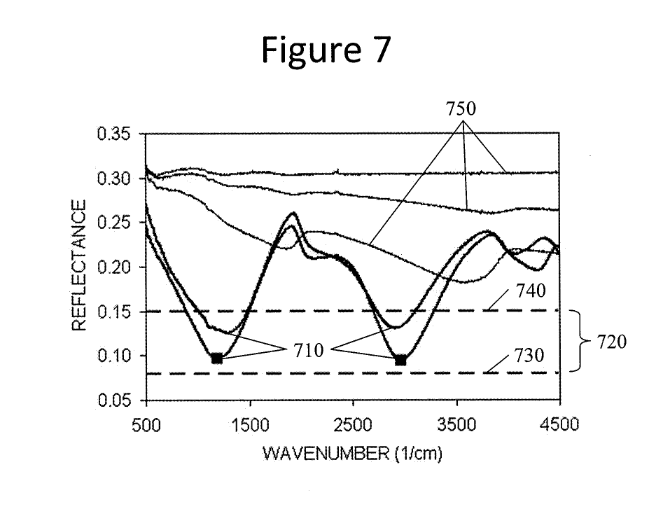

In addition to measuring the trench depth and width of normally processed structures, embodiments of the invention enable the detection of anomalous structures that may fall outside of the normal processing range, both in order to provide defect detection for manufacturing yield control, and to prevent the reporting of inaccurate measurement results from the trench measurement instrument. The test wafer described above having intentional variations in trench width (as illustrated in FIG. 6) also had some anomalous die yielding reflectance spectra significantly different from those corresponding to normally processed structures. In particular, the reflectance intensities of the anomalous die were found to be out of the normal range, as shown in FIG. 7. Exemplary minima 710 fall within a normal range 720, bounded by lower limit 730 and upper limit 740. As discussed above, normal range 720 may be defined by the expected range of the variation of the position of the selected spectral feature, i.e., the limits of the variation of the spectral feature in the model spectra produced during recipe development. The spectra 750 of the anomalous die do not include minima within normal range 720; thus, the anomalous die may be identified for further study, or may be disregarded.

### Example 2

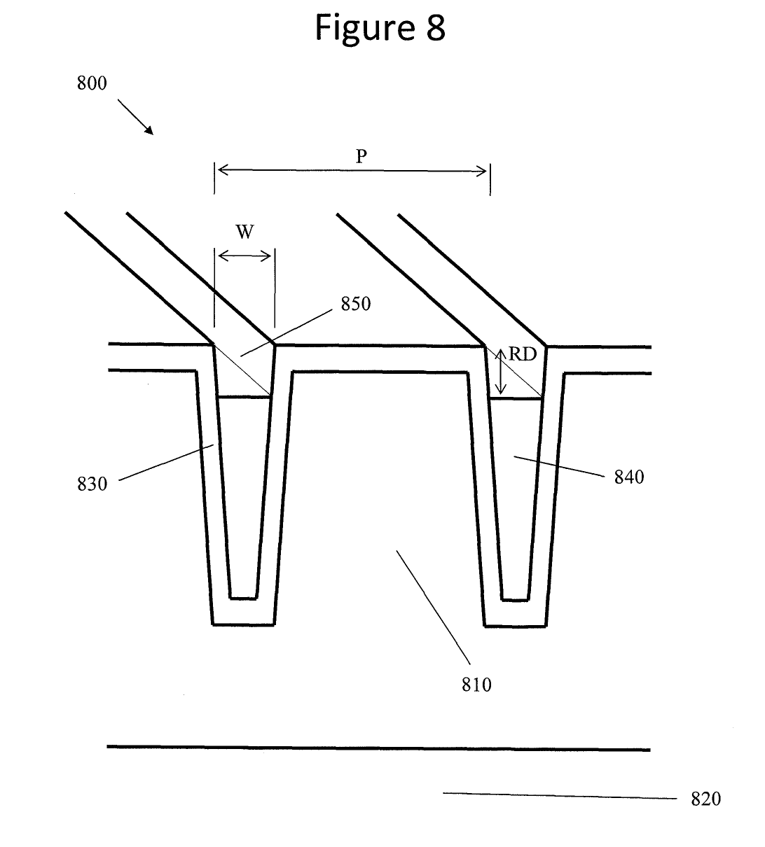

A second example illustrates the utility of embodiments of the invention for more complex structures. FIG. 8 depicts a recessed linear trench structure 800 formed in an undoped epitaxial silicon layer 810 on a doped silicon substrate 820. Structure 800 is formed by etching trenches into the layer 810, coating the trenches with oxide 830, filling with polysilicon 840, and then etching polysilicon 840 to leave a recess 850 extending beneath the top plane of oxide 830. The pitch P is approximately 4.0 μm, with other dimensions approximately in proportion as indicated on the figure. Structure 800 may be found, for example, during formation of power semiconductor devices.

It is desired to measure the recess depth RD of structure 800 by analysis of its infrared reflectance spectrum. Due to the magnitude of the pitch P, the reflectance spectrum in the infrared is dominated by diffraction effects, and RCWA or a similar method is utilized to simulate model spectra. Substrate 820 and polysilicon 840 are doped, while layer 810 is undoped. Doped layers exhibit optical contrast in the infrared region of the spectrum due to the Drude effect of the free carriers associated with the doping.

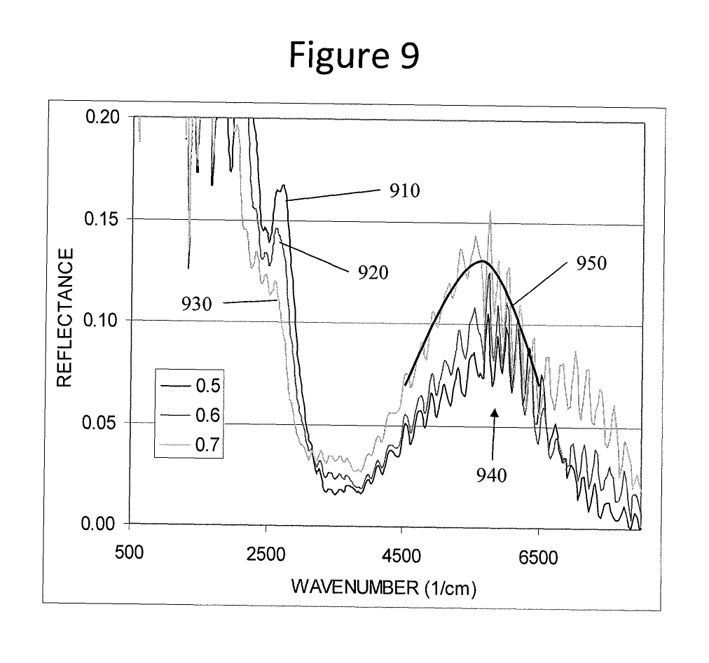

FIG. 9 depicts simulated spectra from trench structure 800, calculated with RCWA. Spectrum 910 corresponds to a recess depth RD of 0.5 μm, spectrum 920 to 0.6 μm, and spectrum 930 to 0.7 μm. The high-frequency oscillation in the spectra 910, 920, 930 is associated with reflections from the interface between substrate 820 and layer 810, and the oscillation frequency depends on the thickness of layer 810. In general, the remaining shape attributes of the spectra 910, 920, 930 depend on the dimensions of structure 800. The intensity of the spectral feature 940 (i.e., the local maximum of a smooth curve drawn through each spectrum) between wavenumbers of 4500 and 6500 cm⁻¹ increases with increasing recess depth RD. Accordingly, feature 940 is identified as a useful feature of the spectra for the purpose of measuring recess depth RD.

The spectra 910, 920, 930 were parameterized by fitting a smooth function (in this case a high-order polynomial) to the region between 4500 and 6500 cm⁻¹, as indicated by the fit line 950 overlaying spectrum 930. The smooth function may be, e.g., a polynomial or other function, and may be fit to the spectrum by, e.g., nonlinear regression. The smooth function preferably has a good fit to the envelope (i.e., the general shape) of the selected area of the spectrum without incorporating any high-frequency oscillations that are present. The maximum height of the fitting function was taken as the spectrum parameter. In accordance with embodiments of the invention as described above, a calibration was then established that related this spectrum parameter to the model parameter of interest, the recess depth RD. As described in Example 1, such analysis may be elaborated to include multiple spectrum parameters and multiple model parameters, e.g., recess depth, recess width, or others, according to the application requirements.

By parameterizing the spectra 910, 920, 930 using a smooth fitting function, the effects of the high-frequency oscillations arising from reflection at the interface between substrate 820 and layer 810 may be ignored. In contrast, a measurement method utilizing a library search, in which a measured spectrum is to be matched with a pre-calculated one, would necessarily incorporate other parameters such as the thickness of layer 810.

It will be seen that the techniques described herein provide a basis for improved metrology of semiconductor materials and devices. The terms and expressions employed herein are used as terms of description and not of limitation, and there is no intention in the use of such terms and expressions of excluding any equivalents of the features shown and described or portions thereof. Instead, it is recognized that various modifications are possible within the scope of the invention claimed.

What is claimed is:

1. A method of characterizing a structure, the method comprising the steps of:
providing a sample comprising a periodic array of structures;
exposing the sample to electromagnetic radiation, wherein the electromagnetic radiation is reflected by, transmitted through, or diffracted by the sample;
thereafter, measuring a spectrum associated with the exposure;
detecting at least one characteristic parameter of the measured spectrum, the at least one characteristic parameter varying identifiably with at least one structural parameter over a range of values of the at least one structural parameter; and
computing the at least one structural parameter based on the at least one characteristic parameter.

2. The method of claim 1, wherein a wavelength of the electromagnetic radiation is less than a diffraction threshold of the sample.

3. The method of claim 1, wherein the at least one characteristic parameter comprises at least one of a position or an intensity of a feature of the spectrum.

4. The method of claim 3, wherein the feature of the spectrum comprises a local maximum or minimum.

5. The method of claim 1, wherein the at least one characteristic parameter corresponds to at least one of a slope, a curvature, an area, or a frequency of a region of the spectrum.

6. The method of claim 1, further comprising fitting a functional form to the spectrum, wherein the at least one characteristic parameter comprises a parameter of the functional form.

7. The method of claim 1, wherein the at least one structural parameter comprises at least one of a depth, a width, a thickness, a pitch, or an angle.

8. The method of claim 1, wherein multiple structural parameters are computed.

9. The method of claim 1, wherein computing the at least one structural parameter comprises operating on the at least one characteristic parameter with a calibration.

10. The method of claim 9, wherein the calibration is established by:
constructing a model of a periodic array of structures, the model including a plurality of structural parameters to be measured;
defining a range of variation for each of the structural parameters;
based on the model, simulating a spectrum of the periodic array of structures over a wavelength range of the radiation;
repeating the simulation for multiple values of the structural parameters over the defined range of variation, thereby forming a plurality of simulated spectra;
identifying characteristics of the simulated spectra having an identifiable variation with respect to the structural parameters;
assigning values to the characteristics of the simulated spectra, thereby obtaining characteristic parameters of the simulated spectra; and
establishing at least one function to relate the characteristic parameters of the simulated spectra to the structural parameters.

11. The method of claim 10, wherein the at least one function comprises at least one of an equation or a table.

12. The method of claim 10, wherein simulating each spectrum accounts for diffraction effects.

13. The method of claim 10, further comprising identifying a plurality of sub-ranges for at least one of the characteristic parameters of the simulated spectra, wherein each function corresponds to a different sub-range.

14. The method of claim 10, further comprising the step of storing the calibration in a library comprising a plurality of records, each record comprising (i) values of the structural parameters used to generate one of the simulated spectra, and (ii) values of the characteristic parameters of the one of the simulated spectra.

15. The method of claim 14, wherein the computing step comprises (i) comparing the at least one characteristic parameter to the characteristic parameters in the library records in order to locate a best-matching record, and (ii) selecting the function corresponding to the best-matching record.

16. The method of claim 9, wherein the calibration comprises a calibration equation including multiple parameters.

17. The method of claim 9, wherein the calibration comprises a calibration equation containing higher powers or cross-products of the characteristic parameters of the simulated spectra or the structural parameters.

18. The method of claim 10, wherein the step of establishing at least one function comprises determining a plurality of calibration factors using a multivariate regression technique.

19. The method of claim 10, wherein the wavelength range includes a wavelength greater than a diffraction threshold of the sample and assigning the values comprises fitting the simulated spectra to an effective medium model.

20. The method of claim 1, wherein the electromagnetic radiation comprises infrared radiation.

21. The method of claim 20, wherein a source of the electromagnetic radiation is spectrally resolved with an FTIR spectrometer.

22. An apparatus for characterizing a periodic structure, the apparatus comprising:
a source of electromagnetic radiation for exposing a structure thereto; and
a detector for (i) measuring a spectrum based on the exposure, (ii) detecting characteristics of the measured spectrum that vary identifiably with at least one structural parameter over a range of values of the at least one structural parameter, and (iii) computing structural parameters based on the characteristics of the measured spectrum.

23. The apparatus of claim 22, wherein the detector comprises:
at least one calibration established by the steps of:
constructing a model of a plurality of structures, the model including a plurality of structural parameters to be measured,
defining a range of variation for each of the structural parameters,
based on the model, simulating a spectrum of the plurality of structures over a wavelength range of the radiation,
repeating the simulation for multiple values of the structural parameters over the defined range of variation, thereby forming a plurality of simulated spectra,
identifying characteristics of the simulated spectra having an identifiable variation with respect to the structural parameters,
assigning values to the characteristics of the simulated spectra, thereby obtaining characteristic parameters of the simulated spectra, and
establishing at least one function to relate the characteristic parameters of the simulated spectra to the structural parameters,
wherein simulating the spectrum includes the effects of diffraction and the at least one function comprises at least one of an equation or a table.

24. The apparatus of claim 22, wherein the electromagnetic radiation comprises infrared radiation.

25. The apparatus of claim 24, wherein the source of electromagnetic radiation is spectrally resolved with an FTIR spectrometer.
